(19) United States
(12) Patent Application Publication
(10) Pub. No.: US 2013/0043404 A1
(43) Pub. Date: Feb. 21, 2013

(54) ION GENERATION DEVICE AND ION DETECTION METHOD IN THE DEVICE

(71) Applicant: Toshiyuki Matsumoto, Osaka-shi (JP)

(72) Inventor: Toshiyuki Matsumoto, Osaka-shi (JP)

(21) Appl. No.: 13/521,202

(22) PCT Filed: Dec. 14, 2010
(86) PCT No.: PCT/JP10/72483

§ 371 Date: Jul. 9, 2012

(30) Foreign Application Priority Data
Jan. 20, 2010 (JP) 2010-010210

(51) Int. Cl. H01T 23/00; H01J 27/02

(52) U.S. Cl. 250/424; 361/230

(57) ABSTRACT

An ion generation device includes an ion generator that generates ions, an ion detector that detects generated ions, a blower that blows the generated ions to outside through a draft air duct, and a control unit that performs drive control of the ion generator and the blower. When the control unit detects absence of generation of ions at a time of starting operation or the like, the control unit stops driving of the ion generator for a short time while keeping the blower driving, and purges staying ions, after which, the control unit carries out ion detection by the ion detector, and determines presence or absence of ion generation. When the control unit determines that ion generation is absent, the control unit continuously performs determination of ion generation a plurality of times, and if ion generation is absent in all the determinations, finally determines generation of ions as absent.

### TECHNICAL FIELD

The present invention relates to an ion generation device including a function of detecting generated ions and an ion detection method.

### BACKGROUND ART

In recent years, the art of purifying the air inside a living space by electrically charging water molecules in the air with positive (plus) and/or negative (minus) ions has been frequently used. For example, in each of ion generation devices including an air cleaner, an ion generator which generates plus ions and minus ions is placed halfway in an internal draft air duct, and the generated ions are released into an external space with air. The ions which electrically charge the water molecules in the purified air inactivate suspended particles, kill suspended bacteria, and denature odor components in a living space. Therefore, the air in the entire living space is purified.

A standard ion generator generates corona discharge to generate plus ions and minus ions by applying a high AC drive voltage between a needle electrode and a counter electrode, or between a discharge electrode and an induction electrode.

When the operation of an ion generator continues for a long period of time, the discharge electrode wears by sputtering evaporation accompanying corona discharge. Further, foreign matters such as chemical substances and dust accumulatively adhere to the discharge electrode. In such a case, discharge becomes unstable, and decrease of the generation amount of ions is unavoidable.

In the ion generation device described in Patent Literature 1, presence or absence of generation of ions is detected, and when it is detected that no ion is generated, a user is informed of necessity of maintenance of the ion generator. Here, the ion generation device is provided with an ion detector to detect presence or absence of generation of ions. The ion detector is provided to face the draft air duct with the ion generator, the ion generator is disposed at an upstream side with respect to an air blowing direction, and the ion detector is disposed at a downstream side thereof.

The ion generation device described in Patent Literature 2 has the function of performing ion detection by stopping a blower in order to enhance ion detection precision. However, the method is required, which can perform ion detection with high precision without stopping the blower as much as possible during operation.

The present applicant files the application of the ion generation device which stops a blower at the time of start of operation, carries out ion detection by an ion detector to determine presence or absence of ion generation, continuously carries out determination of ion generation a plurality of times when it is determined that there is no ion generation, finally determines that there is no ion generation when there is not ion generation in all the determinations, and thereby, avoids determination as no generation of ions in spite of ions being generated (Japanese Patent Application No. 2009-138061).

### CITATION LIST

### Patent Literature

[Patent Literature 1] Japanese Patent Laid-Open Publication No. 2007-114177

### SUMMARY OF INVENTION

### Technical Problem

As described above, in an ion generation device, the ion generator and the ion detector are disposed side by side along the air blowing direction in the draft air duct. The plus ions and minus ions which are generated from the ion generator flow towards the ion detector at the lee side by the wind from the blower. The ion detector collects ions of either plus ions or minus ions and detects them. However, ions passes through the ion detector at a speed of some degree, and therefore, collecting the ions with the ion detector becomes difficult. Therefore, there is a concern that the ion detector detects fewer ions in spite of sufficient ions being generated, and erroneously detects that there is no ion generation.

In view of the above description, an object of the present invention is to provide an ion generation device which can prevent erroneous detection that there is no ion generation in spite of ions being generated, by reliably detecting generated ions by using the characteristics of an ion generator that the ion concentration at a time of starting generation is high, and an ion detection method in the device.

### Solution to Problem

An ion generation device and an ion detection method in the device according to the present invention include an ion generator that generates ions, an ion detector that detects generated ions, a blower that blows the generated ions to outside through a draft air duct, and a control unit that performs drive control of the ion generator and the blower, wherein after the control unit stops driving of the ion generator for a short time while keeping the blower driving, and purges staying ions, the control unit carries out ion detection by the ion detector, and determines presence or absence of ion generation.

When ion generation is stopped while the blower is kept driving, the ions staying around the ion detector are purged. When ions are generated again, the ion detector can detect high-concentration ions directly after generation. Since the blower is kept driving, there remains the possibility of erroneously determining that there is no ion generation, but by performing ion detection a plurality of times, determination precision can be enhanced. Thereby, the erroneous determination that ions are not generated in spite of ions being actually generated can be eliminated.

The control unit carries out ion detection at the time of starting operation. At this time, ion detection is performed while the blower is stopped. Even if the blower is not operated directly after the start of operation, the user is not given a sense of incompatibility. In addition, when ions are not generated, absence of generation of ions can be detected early.

During operation, the control unit carries out ion detection at predetermined timing, and when absence of generation of ions is detected predetermined times, the control unit stops ion generation for a short time while keeping the blower driving and purges staying ions, after which, the control unit generates ions again, carries out ion detection by the ion detector, and carries out ion detection. By performing ion detection a plurality of times during operation, determination precision can be enhanced.

When absence of generation of ions is further detected predetermined times, the blower is stopped, and ion detection is carried out. By performing ion detection a plurality of times during operation, determination precision can be enhanced. When determination is finally performed, the blower is stopped, the influence of wind is eliminated, and presence or absence of generation of ions is detected.

When the control unit detects absence of generation of ions again after detecting absence of generation of ions the plurality of times, the control unit determines that there is an ion generation error, and stops the operation. By determining that generation of ions is absent the predetermined times or more, the final determination is performed. Accordingly, the erroneous determination that there is absence of generation of ions can be reliably eliminated.

The ion generator is made replaceable, and when a new ion generator is attached, the control unit determines the suitability of the ion generator, and in the case of the suitable ion generator, permits operation of the ion generator. The ion generator, which is determined as generating no ions, cannot be used, and therefore, is replaced with a new ion generator. At this time, if an inferior ion generator is attached, the performance as the ion generation device reduces. In order to prevent this, the control unit makes only a suitable ion generator usable, and in the case of an unsuitable ion generator, prohibits operation of the ion generator and makes the ion generator unusable.

### Advantageous Effect of Invention

According to the present invention, after ion generation is stopped for a short time while the blower is kept driving and staying ions are purged, ions are generated again, and the ions are detected, whereby detection precision of the ion detector can be enhanced. Thereby, the erroneous determination that ions are not generated in spite of ions being generated can be reduced, and reliability of ion detection can be enhanced.

### BRIEF DESCRIPTION OF DRAWINGS

FIG. 1 is a sectional view showing one embodiment of an ion generation device according to the present invention.

FIG. 2 is a block diagram showing a schematic configuration of the ion generation device shown in FIG. 1.

FIG. 3 is a front view of an ion generator which is used in the ion generation device shown in FIG. 1.

FIG. 4 is a cross-sectional view of the ion generator shown in FIG. 3.

FIG. 5 is a front view of a collection surface of an ion detector which is used in the ion generation device shown in FIG. 1.

FIG. 6 is a diagram showing a change of an output voltage of the ion detector.

FIG. 7 is a state transition diagram of ion generation determination.

FIG. 8 is a flowchart of a state S1.

FIG. 9 is a flowchart of a state S2.

FIG. 10 is a flowchart of a state S3.

FIG. 11 is a flowchart of a state S4.

### DESCRIPTION OF EMBODIMENTS

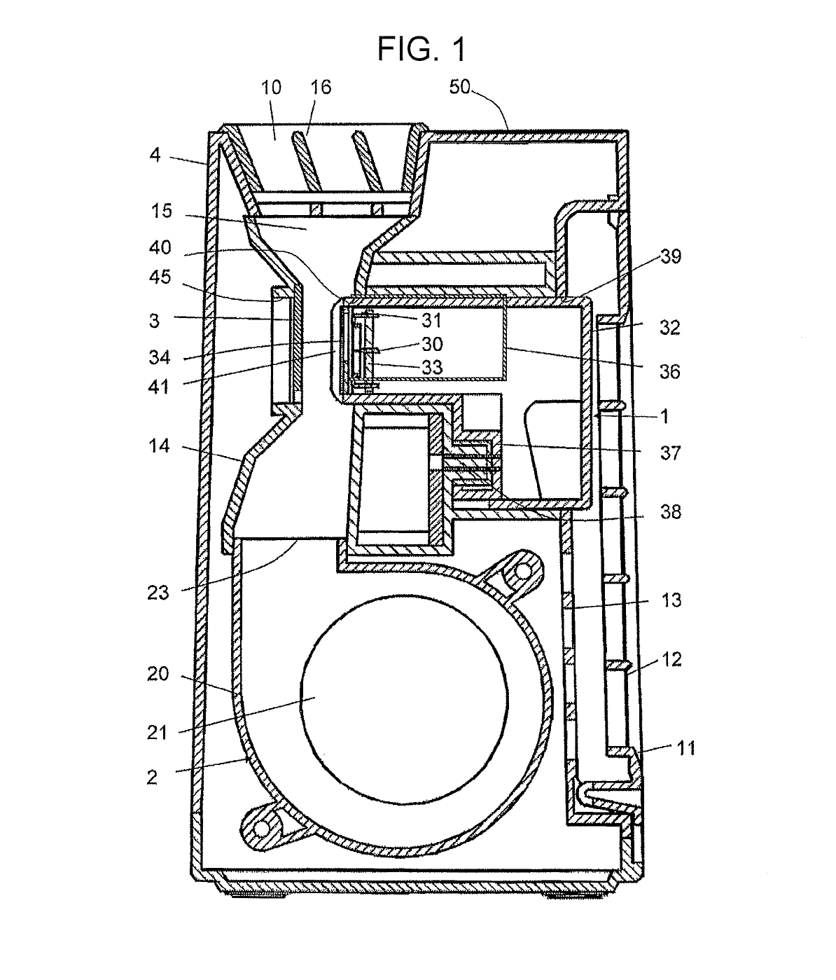

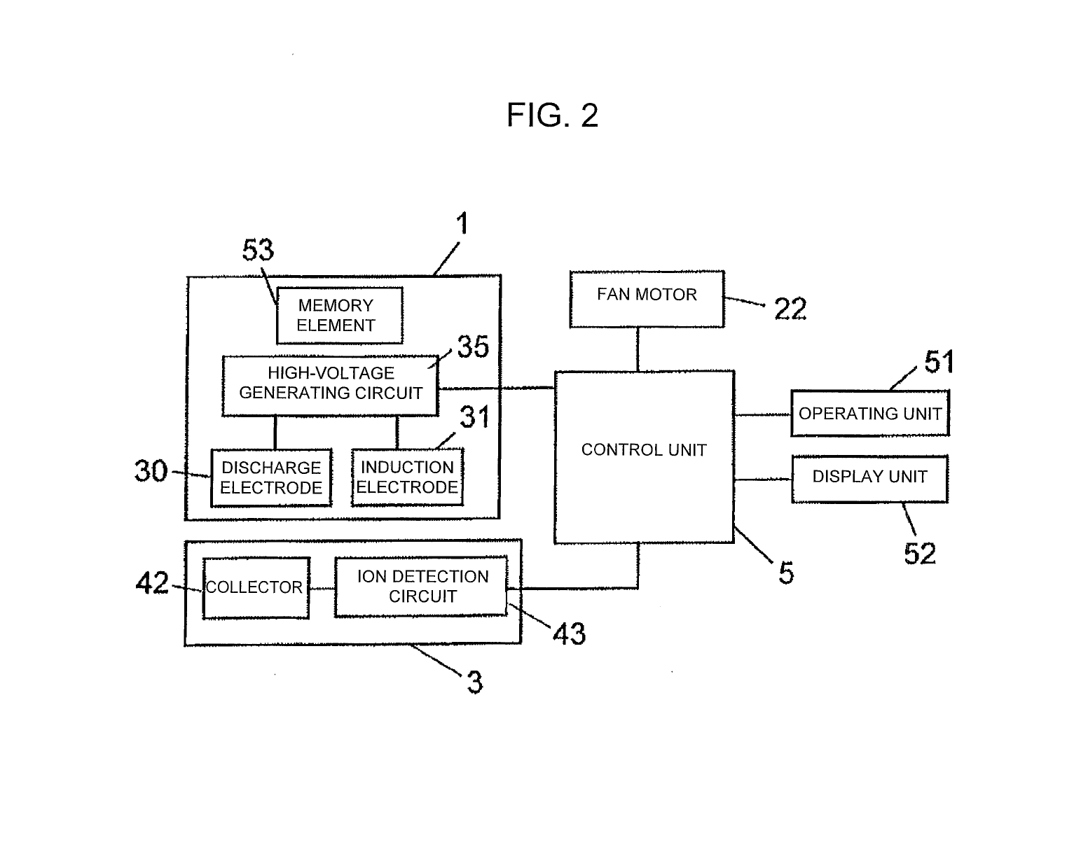

FIG. 1 shows one embodiment of an ion generation device according to the present invention. The ion generation device includes an ion generator 1 which generates ions, a blower 2 for blowing off the generated ions, and an ion detector 3 which detects the generated ions. They are internally installed in a main body case 4. The ion generation device includes a control unit 5 which performs drive control of the ion generator 1 and the blower 2 as shown in FIG. 2. The control unit 5 configured by a microcomputer carries out ion detection by the ion detector 3, and determines presence or absence of ion generation.

A blowoff port 10 is formed in a top surface of the main body case 4, and a cover 11 is attachably and detachably provided on a rear surface of the main body case 4. An inlet port 12 with a filter is formed in the cover 11, and an inlet port 13 is also formed in a lower portion of the rear surface of the main body case 4. A blower 2 is provided in a lower portion of the main body case 4, a duct 14 is provided between the blower 2 and the blowoff port 10. A draft air duct 15 from the blower 2 to the blowoff port 10 is formed, and an interior of the duct 14 is defined as the draft air duct 15.

The duct 14 is formed into the shape of an angular tube, and is wide at an upper side and a lower side, and is narrow in an intermediate portion. An outlet port at an upper end of the duct 14 communicates with the blowoff port 10. The blowoff port 10 is provided with a louver 16 to be attachable and detachable. The ion generator 1 and the ion detector 3 are provided at the duct 14 and face the draft air duct 15. The ion generator 1 and the ion detector 3 are located in the intermediate portion where the draft air duct 15 is the narrowest, and are disposed to face each other. More specifically, the ion generator 1 and the ion detector 3 are provided in a space which occurs by narrowing a width of the duct 14. Consequently, the space in the main body case 4 can be effectively used, and the entire device can be made compact.

The blower 2 is connected to an inlet port at a lower end of the duct 14. The blower 2 is a sirocco fan, a fan 21 is internally installed in a fan casing 20 to be rotatable, and the fan 21 is rotated by a fan motor 22 (FIG. 2). The fan casing 20 is mounted to the main body case 4. A fan blowoff port 23 is formed in a top portion of the fan casing 20, the fan blowoff port 23 is connected to the inlet port of the duct 14, and the fan blowoff port 23 communicates with the draft air duct 15. The air taken in from the inlet ports 12 and 13 by the blower 2 passes through the draft air duct 15 from the lower side to the upper side, and the air accompanied by ions which are generated from the ion generator 1 is blown off from the blowoff port 10. Wind flows in the draft air duct 15 from the lower side toward the upper side, and the direction is called an air blowing direction.

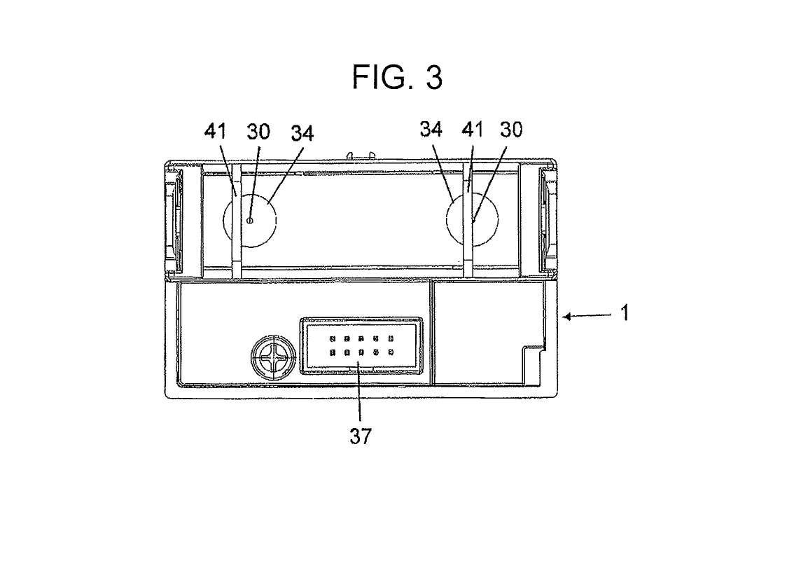

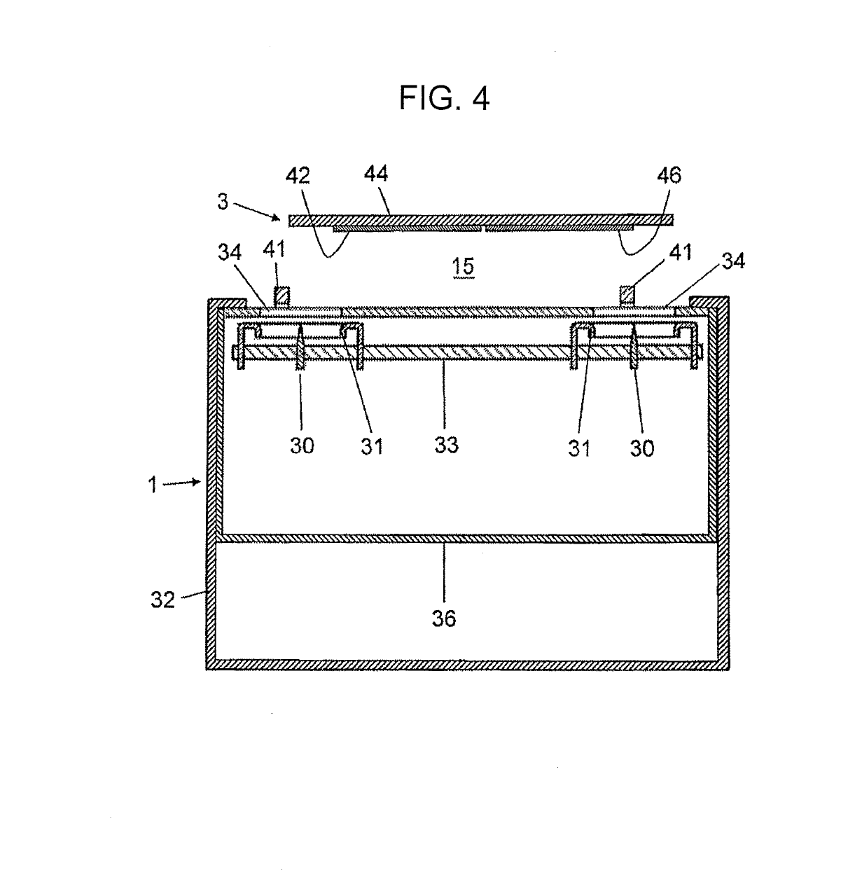

The ion generator 1 has a discharge electrode 30 and an induction electrode 31, and a housing case 32 in which they are installed, as shown in FIGS. 3 and 4. As the discharge electrode 30, a needle electrode is adopted. The induction electrode 31 is formed into a ring shape, and surrounds a periphery of the discharge electrode 30 apart from the discharge electrode 30 by a fixed distance. Each of pairs of the discharge electrodes 30 and the induction electrodes 31 is provided at the left and the right, arranged in a lateral direction orthogonal to the air blowing direction, two sets of the electrodes 30 and 31 are mounted on a supporting substrate 33 with a space therebetween. One of the discharge electrodes 30 is for generating plus ions, and the other discharge electrode 30 is for generating minus ions.

The supporting substrate 33 on which the respective electrodes 30 and 31 are mounted is internally installed in the housing case 32. Two through-holes 34 are formed in a front surface of the housing case 32, and the discharge electrodes 30 face the through-holes 34. The discharge electrodes 30 are located at centers of the through-holes 34. Further, high-voltage generating circuits 35 (FIG. 2) which apply high voltages to the respective discharge electrodes 30 is provided, and is connected to the control unit 5. The discharge electrode 30, the induction electrode 31 and the high-voltage generating circuit 35 are unitized, and an ion generation unit 36 thereof is attachably and detachably fitted in the housing case 32. A pin connector 37 is provided on a front surface of the housing case 32, and is connected to a socket 38 on the main body case 4 side. Through the pin connector 37, a drive signal is inputted into the high-voltage generating circuit 35 from the control unit 5, and a DC-current or an AC-current is supplied thereto.

The housing case 32 is attachable and detachable to and from the main body case 4. An insertion port 39 is formed in the rear surface of the main body case 4, and the housing case 32 is loaded and unloaded from the insertion port 39 in the state in which the cover 11 is removed. When the housing case 32 is inserted in the insertion port 39, a tab which is formed at the housing case 32 is caught by a cutout portion which is formed at the main body case 4 and has elasticity, whereby the housing case 32 is attached. A generation window 40 is formed in a wall on a rear surface side of the duct 14, and when the housing case 32 is attached, the housing case 32 is fitted in the generation window 40. The front surface of the housing case 32 is exposed to the draft air duct 15.

On the front surface of the housing case 32, arch-shaped guard ribs 41 are provided for the respective through-holes 34. The guard rib 41 straddles the through-hole 34. Consequently, a user is prevented from directly touching the discharge electrode 30. When the ion generator 1 is attached to the main body case 4, the guard ribs 41 are protruded into the draft air duct 15 and are arranged parallel with the air blowing direction.

Incidentally, as shown in FIG. 3, the left and right guard ribs 41 differ from each other in the positions with respect to the through-holes 34. In the blower 2, the intake direction and the blowoff direction differ from each other, and therefore, imbalance in the lateral direction occurs to the air blown off from the blower 2, the amount of air toward any one of the discharge electrodes 30 becomes larger, and ion balance of generated plus ions and minus ions is lost. Thus, the guard rib 41 at the side with more wind is located nearer to the center, whereas the guard rib 41 at the side with less wind is located nearer to the outer side. Thereby, at the side with more wind, part of the wind passing in front of the through-hole 34 is shielded by the guard rib 41, the influence of imbalance of the wind can be reduced, and lateral ion balance can be kept.

When a user firmly pulls the housing case 32 out of the main body case 4, the cutaway portion is deformed, the tab is removed therefrom, and the housing case 32 is taken out of the main body case 4. The housing case 32 is made openable and closable, and by opening the housing case 32, the ion generation unit 36 is taken out. In this manner, the ion generator 1 can be handled as a cartridge. For example, when the ion generator 1 reaches the end of its life, the ion generator 1 can be replaced with a new cartridge. The old cartridge is decomposed, and maintenance of the ion generator unit 1 is carried out, whereby the cartridge can be regenerated and becomes reusable.

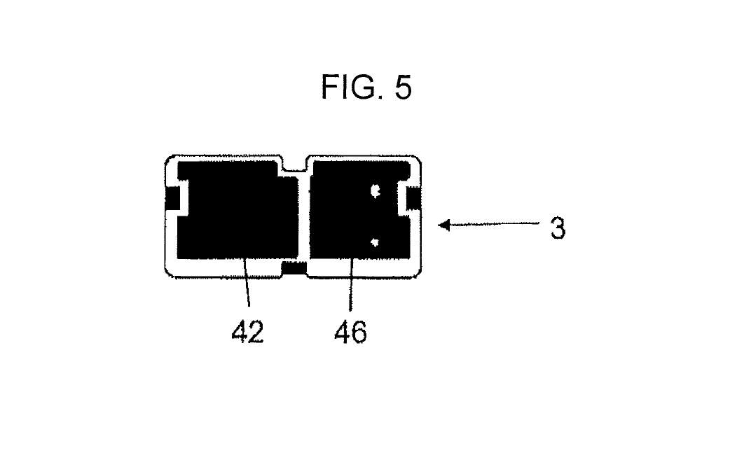

The ion detector 3 has a collector 42 which collects generated ions, and an ion detection circuit 43 which outputs a detection signal corresponding to the collected ions to the control unit 5 (FIG. 2). The collector 42 having conductivity is a collection electrode provided on a front surface of a circuit board 44, and is formed from a copper tape, as shown in a front view of the collection surface of the ion detector which is FIG. 5. The ion detection circuit 43 is mounted on a back surface of the circuit board 44. The collector 42 and the ion detection circuit 43 are electrically connected in the board 44, and the ion detection circuit 43 is connected to the control unit 5 via a lead wire.

The ion detection circuit 43 is publicly known and configured by a diode for rectification, a p-MOS type FET and the like, as described in, for example, Japanese Patent Laid-Open Publication No. 2007-114177. The ion detector 3 detects either plus ions or minus ions. When the collector 42 collects one kind of ions of both kinds of generated ions, the potential of the collector 42 rises. The potential rises in accordance with the amount of collected ions. The ion detection circuit 43 A/D-converts the output voltage corresponding to the potential and outputs it to the control unit 5. The control unit 5 performs determination about ion generation based on the input value from the ion detector 3.

The ion detector 3 is provided in the draft air duct 15. More specifically, as shown in the sectional view of the ion generation device which is FIG. 1, and in the cross-sectional view of the ion generator which is FIG. 4, the circuit board 44 is fitted in the detection window 45 which is formed in the wall at the front surface side of the duct 14. The front surface of the circuit board 44 is exposed to the draft air duct 15, and is opposed to the front surface of the ion generator 3 with the draft air duct 15 therebetween. The collector 42 is disposed to be shifted to one side in the lateral direction. The collector 42 is located in front of the discharge electrode 30 which generates one kind of ions, and is not located in front of the other discharge electrode 30. Thereby, the collector 42 can intensively collect the one kind of ions.

From the ion generator 1, plus ions and minus ions are generated. The ion detector 3 is likely to collect not only one kind of ions desired to be collected, but also the other kind of ions. In order to prevent collection thereof, the ion detector 3 is provided with a protector 46. The protector 46 made of a metal plate is provided on a front surface of the circuit board 44 to cover a part thereof. The protector 46 is disposed to face the other discharge electrode 30 which generates ions with reversed polarity from the ions to be collected. The collector 42 and the protector 46 are electrically insulated from each other. The ions generated from the other discharge electrode 30 are collected by the protector 46, the ions going to the collector 42 decrease, and the ions with the reversed polarity are prevented from being collected by the collector 42.

As shown in FIG. 4, disposition of the collector 42 is settled so as to face the discharge electrode 30 at the left side in the drawing. Since the guard rib 41 is disposed to be deviated from the center of the discharge electrode 30, generation and diffusion of ions are not hindered, and the collector 42 can reliably collect the generated ions.

In this case, the space between the ion generator 1 and the ion detector 3 is defined to be a predetermined distance. By corona discharge between the discharge electrode 30 and the induction electrode 31, ions are generated from the discharge electrode 30. At this time, ions spread towards the opposed ion detector 3, and high-concentration ions are distributed in a dome shape with the tip end of the discharge electrode 30 as a center. If the tip end of the discharge electrode 30 and the wall of the duct 14 and the ion detector 3 which are opposed to each other are too close, discharge occurs in the space from the discharge electrode 30. Discharge becomes unstable, and the discharge does not continue. Thus, the distance from the front surface of the ion generator 1 to the front surface of the ion detector 3 is set at a predetermined distance, for example, 10 mm or more so that the wall of the duct 14 and the ion detector 3 do not inhibit ion generation. The narrowest space of the duct 14 is set in accordance with the distance. By defining the distance like this, ions can be stably generated. Further, ions in the state of the highest concentration directly after being generated are present between the ion generator 1 and the ion detector 3, and therefore, generation of the ions can be accurately detected.

An operation panel 50 (FIG. 1) is provided on the top surface of the main body case 4, and the operation panel 50 includes an operating unit 51 having an operation switch and the like, and a display unit 52 (FIG. 2). When the operation switch is operated, the control unit 5 drives the ion generator 1 and the blower 2, and operates the display unit 52 to indicate that the device is under operation. In FIG. 2, reference sign 53 designates a rewritable nonvolatile memory element such as an EEPROM, and the memory element stores the information relating to the ion generator 1.

When the ion generation device is operated, plus ions are generated from one of the discharge electrodes 30 of the ion generator 1, and minus ions are generated from the other discharge electrode 30. The generated ions are carried by the air blown from below by the blower 2, and blown off outside from the blowoff port 10. The released ions decompose and remove suspended fungi and viruses in the air.

When the ion generation device 1 is used for a long time, the discharge electrode 30 is deteriorated, dust adheres to the respective electrodes 30 and 31, and discharge becomes unstable. The generated ions decrease, and the above described effect cannot be obtained. Thus, the control unit 5 of the ion generation device 1 calculates the sum of the operating hours, and when the total operating time reaches a replacement notice time, for example, 17500 hours, the control unit 5 performs display for urging the user to replace the ion generator 1 in the display unit 52, for example. Thereafter, the operation is performed, but when the total operating time reaches the replacement time, for example, 19000 hours, the control unit 5 determines that the ion generator 1 reaches the end of its life, stops the operation and informs the user of replacement.

However, depending on the environment in which the ion generation device is used, dust, moisture, oil mist and the like adhere to the discharge electrode 30, and before the above described time elapses, the ion generator 1 sometimes reaches the end of its life. When the ion generator 1 reaches the end of its life, the ion generation amount decreases, or ions are not generated. The ion detector 3 detects generation of ions, and the control unit 5 determines presence or absence of ion generation based on the inputted value from the ion generator 1. Subsequently, when the control unit 5 determines that there is no generation of ions, the control unit 5 stops operation, and performs display to replace the ion generator 1.

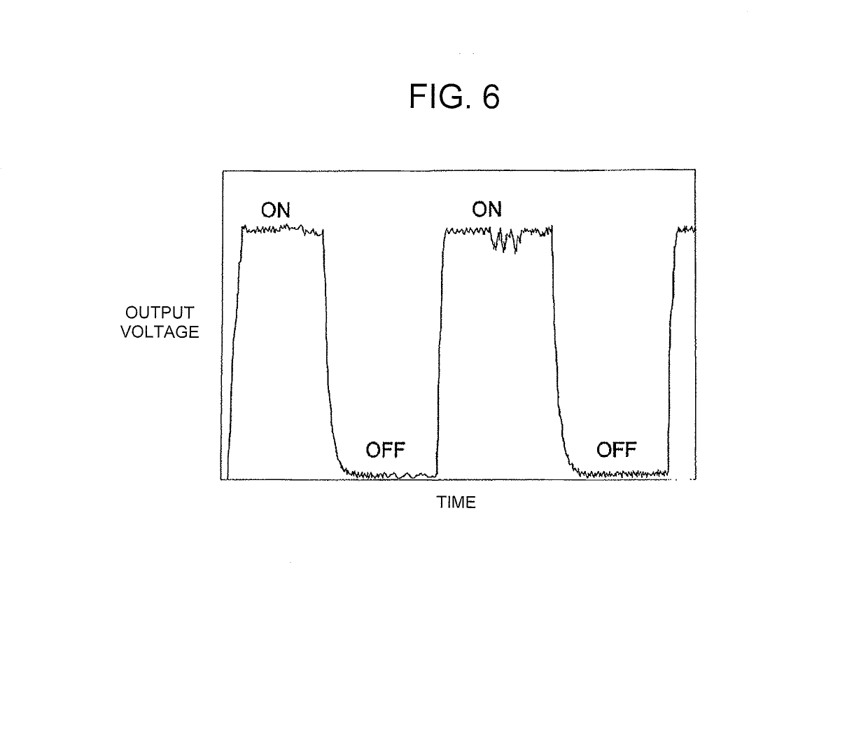

When the control unit 5 carries out ion detection, the control unit 5 turns on the ion generator 1 for a predetermined time, and subsequently turns off the ion generator 1 for the same predetermined time. The turning on and off is repeated for an ion determination time which is set in advance. During the time, the ion detector 3 detects ions. The output voltage from the ion detector 3 at this time is shown in FIG. 6. When the ion generator 1 is on, ions are generated, and therefore, the output voltage rises and is saturated to be a constant voltage. When the ion generator 1 is off, ions are not generated, and therefore, the output voltage becomes substantially 0 V.

The input value corresponding to the output voltage from the ion detector 3 is inputted in the control unit 5. The control unit 5 calculates a difference between the maximum value and the minimum value of the input values detected during the ion determining time, determines whether or not the difference is a threshold value or more, and determines presence or absence of ion generation. When the difference of the maximum value and the minimum value is the threshold value or more, the control unit 5 determines that ion generation is present. When the difference of the maximum value and the minimum value is less than the threshold value, the control unit 5 determines that ion generation is absent. The threshold value is set at 0.5 V. The value is set based on the output voltage which is outputted from the ion detector 3 when the ion generator 1 is turned on and off by the discharging times when the ion concentration decays to half the ion concentration at the time of the standard discharge times per unit time.

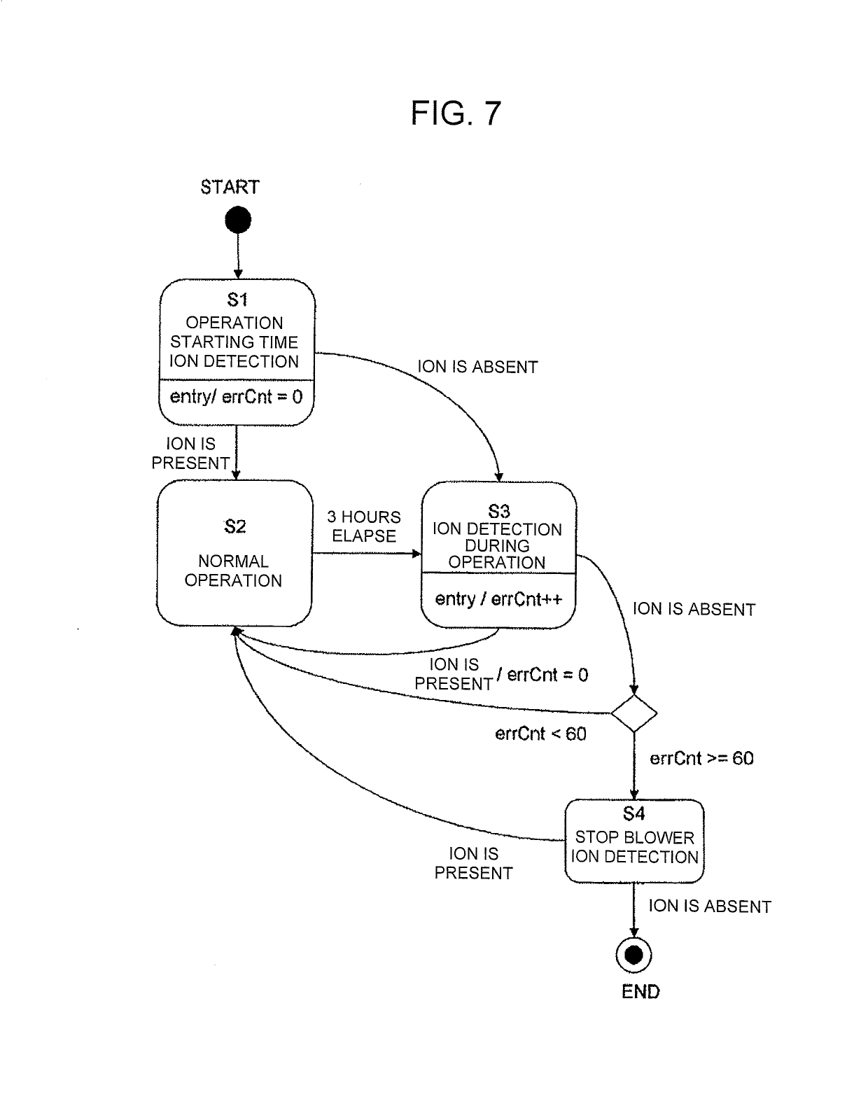

FIG. 7 shows a state transition diagram of ion generation determination. The state transition diagram shows four states of S1 (operation starting time ion detection), S2 (normal operation), S3 (ion detection during operation), and S4 (blower stop ion detection). When operation of the ion generation device 1 is started, the state of S1 is brought about, and ion detection at the time of starting operation is performed. When ion generation is present, the state shifts to the normal operation of S2, and ion detection of S3 is performed at each predetermined timing. When ion generation is present in S3, normal operation of S2 and ion detection of S3 are repeated.

When ion detection is absent in S1, the state shifts to S3 and ion detection is performed. When it is determined that ion generation is absent a predetermined times in S3, determination is performed again in S4, and it is finally determined whether or not an ion generation error occurs. When it is determined that an ion generation error occurs, the operation is stopped.

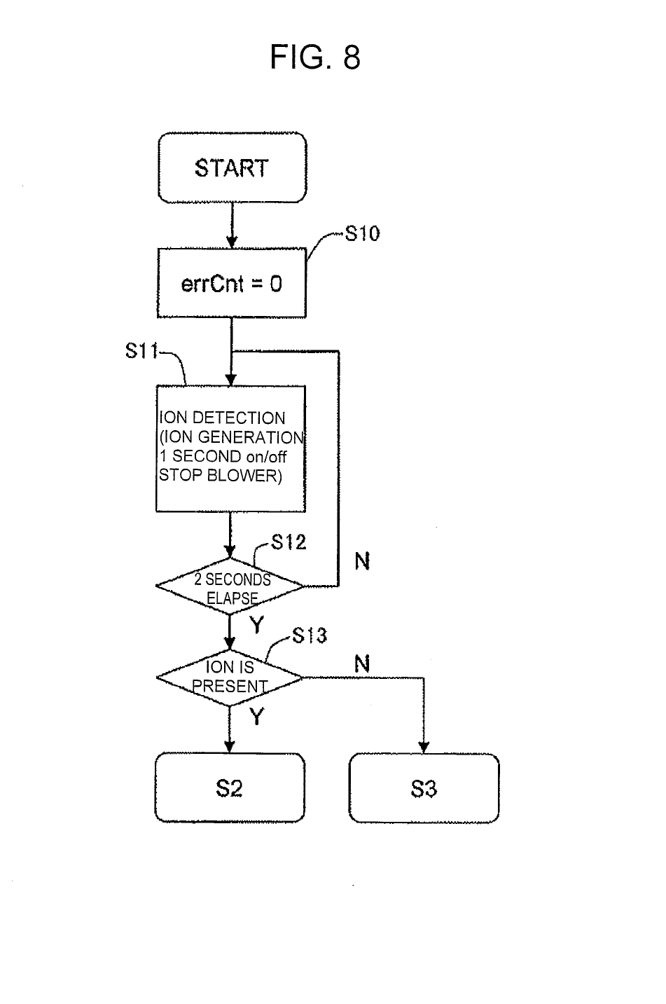

When the operation is started as described above, the control unit 5 performs determination of ion generation a plurality of times. First, at the time of starting the operation, the control unit 5 performs ion determination of S1. As shown in FIG. 8, an error counter is reset to zero (step 10; abbreviated as “S10”, and the same shall apply hereinafter). The ion determining time is set as the minimum time of 2 seconds, the control unit 5 stops the blower 2, turns on the ion generator 1 for 1 second/off for 1 second (S11), determines whether 2 seconds elapses (S12), performs ion detection, and determines presence or absence of ion generation based on sensor input (S13).

When the control unit 5 determines that ion generation is present, the control unit 5 shifts to the normal mode (S2).

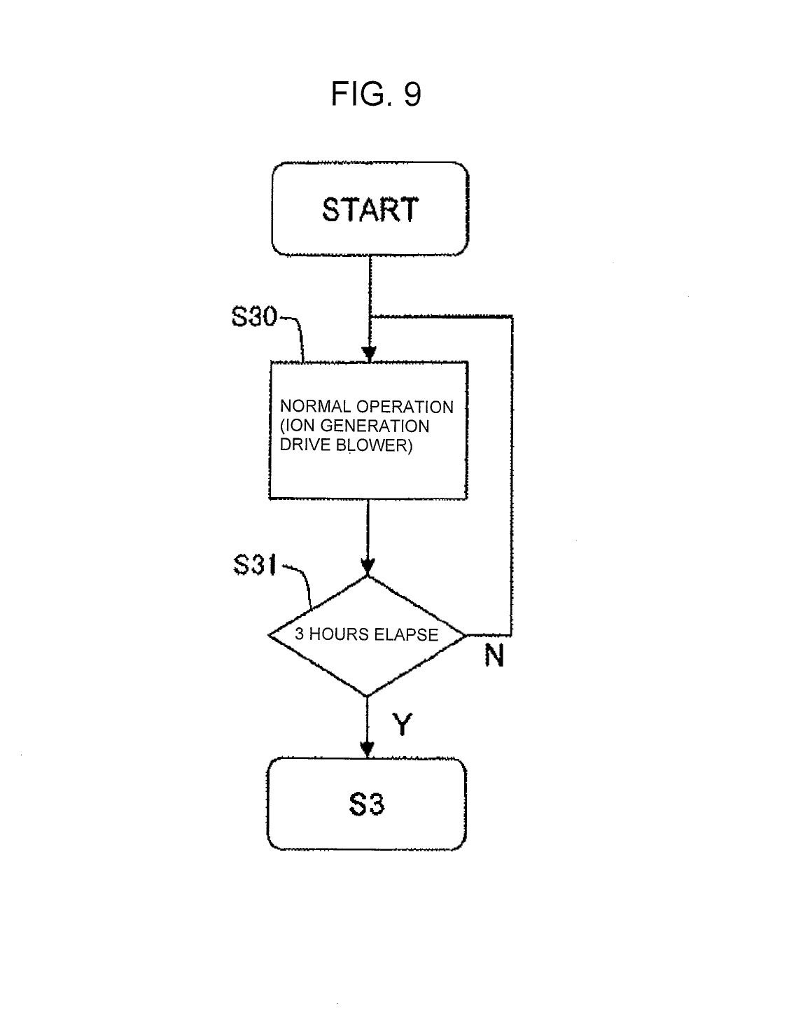

As shown in FIG. 9, in the normal mode, the normal operation of generating ions and driving the blower is performed, for a predetermined time, for example, 3 hours without performing determination of ion generation (S30). When the control unit 5 determines whether or not 3 hours elapses (S31), and when 3 hours elapses, the control unit 5 performs ion determination of S3.

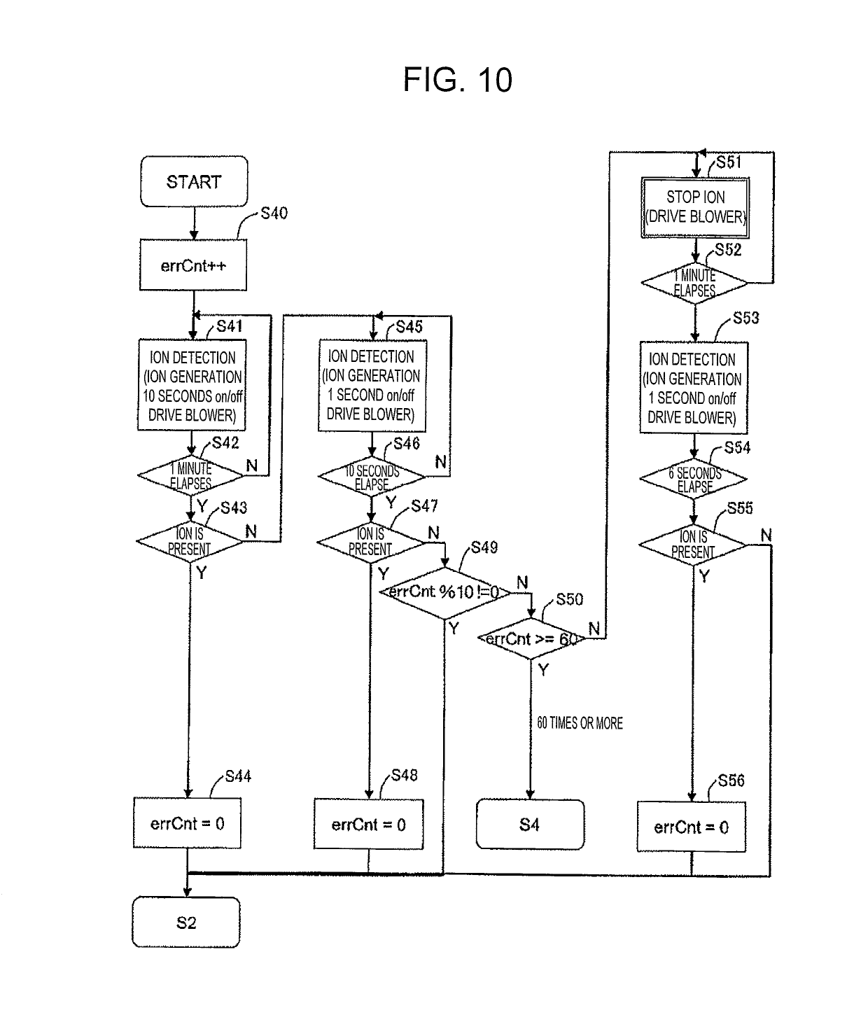

As shown in FIG. 10 as a flowchart of the state S3, one is added to the error counter (S40), the ion determining time is set to be long, the ion generator 1 is turned on for 10 seconds/off for 10 seconds while the blower 2 is driven (S41), ion detection is performed, during the ion determining time of 1 minute which is the first time period (lapse of 1 minute is awaited (S42)), and presence or absence of ion generation is determined (S43). On and off are performed three times in 1 minute, but determination may be performed one time based on the difference of the maximum input value and the minimum input value in 1 minute, or determination may be performed three times in total based on the difference between the maximum input value and the minimum input value in each on and off at one time.

When determining that ion generation is absent, the control unit 5 sets the ion determining time to be short, turns on the ion generator 1 for 1 second/off for 1 second while driving the blower 2, performs ion detection during the ion determining time of 10 seconds which is the second time period (S45 and S46), and determines presence or absence of ion generation (S47). The control unit 5 performs determination of one time based on the difference between the maximum input value and the minimum input value in 10 seconds, or determination of five times in total based on the difference between the maximum input value and the minimum input value at each on and off of one time.

When determining that ion generation is absent, the control unit 5 stops ion generation (S51), turns on the ion generator 1 for 1 second/off for 1 second after a lapse of 1 minute (S52), performs ion detection during the ion determining time of 6 seconds (S53), and after the lapse of 6 seconds (S54), determines presence or absence of ion generation (S55). By purging the staying ions, the ion detector can detect ions precisely.

When the control unit 5 determines that ion generation is present in each ion determination described above, the control unit 5 resets the error counter (S44, S48 and S56), and shifts to the normal mode (S2).

When the control unit 5 determines that ion generation is absent in the determination of S47, the control unit 5 checks whether or not the count value of the error counter is a multiple of ten (S49). When it is correct that the remainder of the result of dividing the error count value (errCnt) by ten (“errCnt% 10”) is not zero (determination of S49 is Y), the flow shifts to the normal mode (S2). When the error counter is a multiple of ten (it is erroneous that the remainder is non-zero, that is, determination of S49 is N), the flow shifts to S50, and when the error count value is not 60 or more (determination of S50 is N), a series of control steps from purge of ions to the determination of presence or absence of ion generation of the above described S51 to S55. When the determination of S50 is Y, that is, the error count value is 60 or more, the control unit 5 shifts to the mode of the state S4.

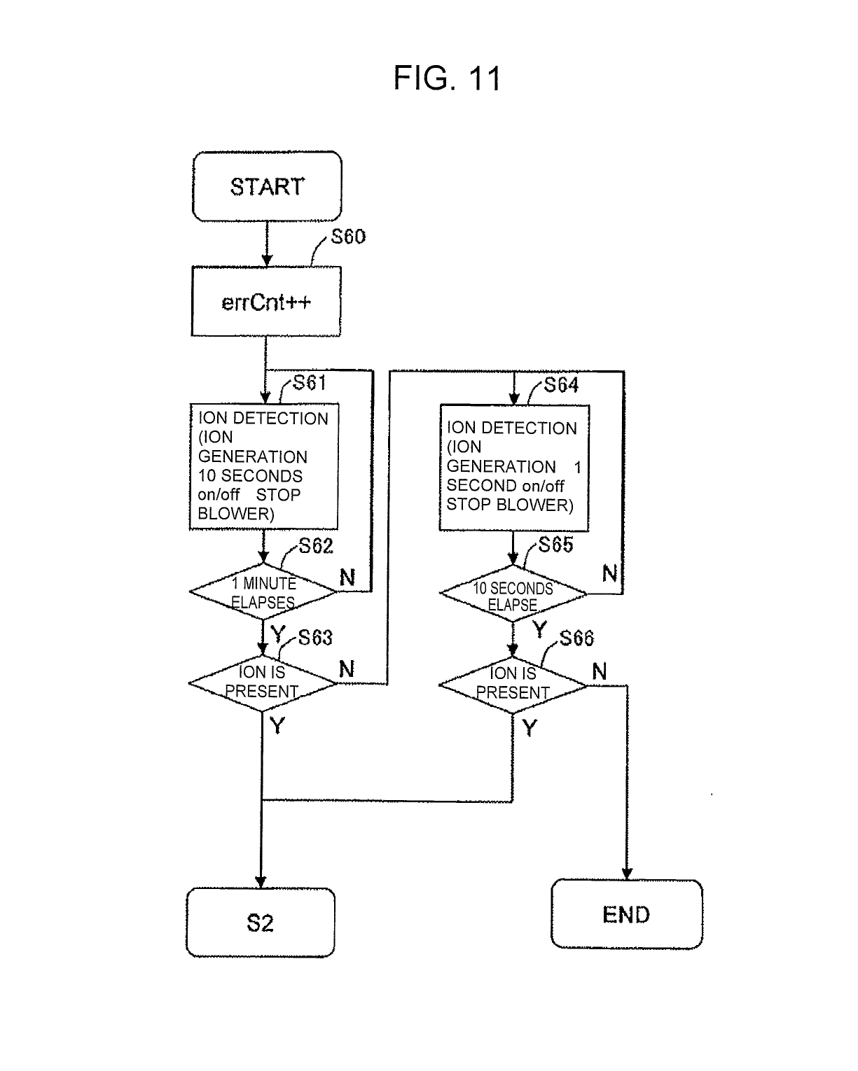

As shown as the flowchart of the state S4 in FIG. 11, the error counter is counted up by one (S60), the ion determining time is set to be long, the blower 2 is stopped, the ion generator 1 is turned on for 10 seconds/off for 10 seconds, performs ion detection during ion determining time of 1 minute (S61), and the presence or absence of ion generation is determined as in the above description. More specifically, after the lapse of 1 minute (S62), presence or absence of ion generation is determined (S63).

When it is determined that ion generation is absent in the determination of S63, the ion determining time is set to be short, the ion generator 1 is turned on for 1 second/off for 1 second while the blower 2 is kept stopping, ion detection is performed (S64) during the ion determining time of 10 seconds, and presence or absence of ion generation is determined. More specifically, after the lapse of 10 seconds (S65), presence or absence of ion generation is determined (S66).

When the control unit 5 determines that ion generation is present in the determination of S66, the flow shifts to the normal mode (S2). When the control unit 5 determines that ion generation is absent in the determination of S66, the control unit 5 determines that an ion generation error occurs. Subsequently, the control unit 5 immediately stops all loads, stops operation, and operates the display unit 52 to perform error display.

As above, when an error is detected when presence or absence of ion generation is determined, ion generation is stopped and staying ions are purged, after which, ion detection is performed, whereby precision of ion detection can be enhanced.

Incidentally, if an ion generation error occurs to the ion generation device, operation of the ion generation device cannot be performed. The user removes the ion generator 1 from the main body case 4, and a new ion generation device 1 is attached. Since the old ion generator 1 is decomposable, the ion generation unit 36 is removed, and maintenance such as cleaning of the discharge electrode 30 is performed, whereby the ion generator 1 is regenerated, and becomes usable.

Thus, the memory element 53 (FIG. 2) is provided in the ion generation unit 36 of the ion generator 1. The memory element 53 stores identification information, and maintenance information such as the number of recycling times. An information processing device such as a personal computer writes these kinds of information into the memory element 53, and reads the information. When the regenerated ion generator 1 is attached to the main body case 4, the control unit 5 determines suitability of the ion generator 1. More specifically, the control unit 5 reads identification information from the memory element 53 of the ion generator 1. The identification information of a plurality of usable ion generators 1 is registered in the memory in advance, and the control unit 5 checks the read identification information against the registered identification information. When the read identification information coincides with the registered information, the control unit 5 recognizes the ion generator as the genuine ion generator 1, and permits operation of the ion generator 1. When the read information and the registered information do not coincide with each other, the control unit 5 determines that the ion generator is not a genuine product, and prohibits operation of the ion generator 1. Thereby, only the genuine products of the ion generators 1 can be used, inferior imitations can be eliminated, and the function of the ion generation device can be kept.

The present invention is not limited to the above described embodiment, many corrections and changes can be added to the above described embodiment within the range of the present invention as a matter of course. As the memory element provided in the ion generator, an IC tag may be used.

### REFERENCE SIGNS LIST

1 ion generator

2 blower

3 ion detector

4 main body case

5 control unit

10 blowoff port

14 duct

15 draft air duct

20 fan casing

21 fan

22 fan motor

30 discharge electrode

31 induction electrode

32 housing case

34 through-hole

35 high-voltage generating circuit

41 guard rib

42 collector

43 ion detection circuit

46 protector

1. An ion generation device, comprising:
an ion generator that generates ions;
an ion detector that detects generated ions;
a blower that blows the generated ions to outside through a draft air duct; and
a control unit that performs drive control of the ion generator and the blower,
wherein after the control unit stops driving of the ion generator for a short time while keeping the blower driving, and purges ions staying at the ion detector, the control unit drives the ion generator again, performs ion detection by the ion detector, and determines presence or absence of ion generation.

2. The ion generation device according to claim 1,
wherein when ion detection is not performed at a time of starting operation of the ion generation device, or when a predetermined time of normal operation of the ion generation device elapses, the control unit drives the ion generator while keeping the blower driving and carries out the ion detection, and performs a series of controls from the purge of the ions to the determination of presence or absence of the ion generation by the control unit, in response to determining that there is no ion in the ion detection.

3. The ion generation device according to claim 2,
wherein when the absence of generation of the ions is detected at an initial time, the control unit performs the ion detection that is performed by driving the ion generator while keeping the blower driving for a relatively long first time period, and at a second and following times when the absence of generation of the ions is detected, the control unit performs the ion detection that is performed by driving the ion generator while keeping the blower driving for a second time period which is shorter than the first time period.

4. The ion generation device according to claim 2,
wherein in response to an absence of generation of ions being detected predetermined times, in the ion detection that is performed by driving the ion generator while keeping the blower driving, the control unit performs a series of controls from purge of the ions to determination of presence or absence of the ion generation by the control unit.

5. An ion detection method in an ion detection device comprising, an ion generator that generates ions, an ion detector that detects generated ions, a blower that blows the generated ions to outside through a draft air duct, and a control unit that performs drive control of the ion generator and the blower,
wherein by drive control of the ion generator and the blower by the control unit, drive of the ion generator is stopped for a short time while the blower is kept driving, and ions staying at the ion detector are purged, after which, the ion generator is driven again, ion detection by the ion detector is performed, and presence or absence of ion generation is determined.

6. The ion generation device according to claim 3,
wherein in response to an absence of generation of ions being detected predetermined times, in the ion detection that is performed by driving the ion generator while keeping the blower driving, the control unit performs a series of controls from purge of the ions to determination of presence or absence of the ion generation by the control unit.
